(19) United States
(12) Patent Application Publication
(10) Pub. No.: US 2005/0260240 A1
(43) Pub. Date: Nov. 24, 2005

(54) Rain-fast bioactive compositions

(75) Inventors: Kolazi S. Narayanan, Wayne, NJ (US); Jayanti Patel, Elmwood Park, NJ (US); Karen Winkowski, Sayreville, NJ (US)

Correspondence Address: Attn: William J. Davis, Esq.;INTERNATIONAL SPECIALTY PRODUCTS, Legal Department, Building No. 8, 1361 Alps Road, Wayne, NJ, 07470, US

(73) Assignee: ISP INVESTMENTS INC.

(21) Appl. No.: 10/850,546

(22) Filed: May 20, 2004

(51) Int. Cl. A01N 25/00

(52) U.S. Cl. 424/405

(57) ABSTRACT

A rain-fast bioactive composition includes a bioactive substance and an aqueous suspension concentrate of a latex polymer emulsified with an in-situ crosslinked hydrocarbon polymer.

### BACKGROUND OF THE INVENTION

1. Field of the Invention

This invention relates to bioactive compositions, and, more particularly, to bioactive compositions which are rain-fast when applied to a substrate.

2. Description of the Prior Art

There is a need to provide rain-fastness for bioactive materials, such as agriculturally active chemicals, e.g. fungicides, insecticides and herbicides. Retention of these actives on the intended site, e.g. a plant, even under severe rain conditions is a desirable objective of this art. Also, in the building materials industry, e.g. for gypsum boards, it is desired to provide both rain-fastness and sustained release of a preservative thereon, e.g. a fungicide or a mildewicide, to protect the board against mold formation, even under submerged water conditions.

Accordingly, it is an object of this invention to provide a composition which provides rain-fastness for bioactive materials delivered onto a substrate.

### SUMMARY OF THE INVENTION

What is described herein is a composition and a method for increasing the rain-fastness of a bioactive ingredient which is applied to a substrate. The composition includes a water thickener which is a suspension concentrate of a latex polymer which is emulsified with an in-situ crosslinked hydrocarbon polymer.

Suitably, the rain-fast bioactive composition comprises:
(a) a bioactive ingredient, and
(b) a suspension concentrate of a latex polymer emulsified with an in-situ crosslinked hydrocarbon polymer.

Preferably, (b) includes 12-14% by weight of the polymer in water.

### DETAILED DESCRIPTION OF THE INVENTION

The method of the invention for increasing the rain-fastness of a bioactive composition which is applied to a substrate such as a plant is particularly characterized by including therein a water thickener which is a suspension concentrate of a latex polymer which is emulsified with an in-situ crosslinked hydrocarbon polymer.

The substrate also may be a building material, e.g. gypsum board or sheet rock.

Accordingly, the rain-fast bioactive composition of the invention comprises:
(a) a bioactive substance, and
(b) a suspension concentrate of a latex polymer emulsified with an in-situ crosslinked hydrocarbon polymer.

Preferably wherein (b) comprises about 12-14% by weight of the polymer in water.

A suitable latex additive polymer for use herein is a polymer emulsified with an in-situ crosslinked hydrocarbon polymer; present as an additive to a suspension concentrate of the bioactive ingredient. Preferably such polymer is the commercially available polymer composition known as “ASS-HF-NT 800”, sold by the Bohme Co. of Switzerland.

A suitable active ingredient is an agricultural chemical, e.g. 40% by weight of chlorothalonil.

The composition of the invention may be used in the following manner:
1. Additive in spray tank
2. Additive in aqueous suspensions
3. Coating media for fertilizer granules
4. Coating media for seeds and granular products
5. Sprayable coating on textiles to preserve protective additives

The invention will now be described with particular reference to the following examples.

### Determination of Rain-Fastness of Compositions of Invention Preparation of Suspension Concentrates

Polymeric dispersants are dispersants of choice for formulating suspension concentrates, suspoemulsions, and, solid delivery systems (WP, WDG, and Tablets). EASY-SPERSE®¹ are such polymeric dispersants, based on partially neutralized methyl vinyl ether/maleic acid half esters (ethyl/butyl) copolymers (MVE-MAHE) (U.S. Pat. No. 6,156,803). These polymeric dispersants are capable of producing superior dispersions for a host of active ingredients like herbicides, insecticides, fungicides, growth regulators, organic dyes, inorganic pigments, and water-insoluble polymers.
¹EASY-SPERSE is a trademark of International Specialty Products, Wayne, N.J. 07470

Suspension concentrates were prepared herein by wet milling using an Eiger Machinery Model #100. The suspension concentrate formulated contained active ingredient, e.g. pesticide, dispersing agent, co-dispersant, thickener, antifreeze, preservative and antifoam.

A typical suspension concentrate is shown in Table 1 below:

TABLE 1
Typical Base Suspension Concentrate of Invention

| Ingredient | Composition % (w/w) | Function |
|---|---|---|
| EASY-SPERSE ® (as solid) | 0.50 | Dispersing agent |
| PVP K-30 | 2.60 | Co-dispersant |
| Chlorothionil | 41.0 | Pesticide |
| KELZAN ®² | 0.15 | Thickener |
| Propylene glycol | 3.50 | Antifreeze |
| PROXEL ® GXL³ | 0.25 | Preservative |
| RHODORSIL ® 426R⁴ | 0.20 | Antifoam |
| Water | Qs to 100 | Solvent |

²KELZAN is a trademark of Kelco Biopoymers, Tadworth, Surrey KT20 5HQ, UK
³PROXEL GXL is a trademark of Avecia Inc, Wilmington, DE 19850-5457
⁴RODORSIL antifoam 426R is a trademark of Rhodia Inc, Cranbury, NJ 08512-7500

Prior to feeding into the wet mill, the suspension compositions were mixed using a homogenizer. Typically, a 70% to 80% loading of 0.1 cm zirconium oxide beads was used and concentrates of 150 g were milled for 10 minutes at 3000 rpm. The temperature of the cooling bath was typically 0° to 5° C., which gave a milling temperature between 15° C. and 21° C. for the concentrates. The operating conditions of the wet-mill resulted in about 11/3 passes of the concentrate per minute.

Procedure for 75-100 g Batch

A procedure was developed to screen formulations on a small scale. In a 250 ml stainless steel Waring blender, 36.75 g of following solution was added.

| | | | |
|---|---|---|---|
| | 1.50 g | EASY-SPERSE ® | [primary dispersant] |
| | | (MVE-MAHE) (25%) | |
| | 0.15 g | RHODORSIL 426R ® | [defoamer] |
| | 1.9 g | PVP K-30 | [co-dispersant/binder] |
| | 2.63 g | Propylene glycol | [antifreeze] |
| | 0.075 g | PROXEL GXL ® | [preservative] |
| | 30.45 g | Water | [solvent] |
| Total: | 36.75 g | | |

The above charge was placed in a Waring blender and the power was increased slowly through a Variac controller to avoid splashing. Stirring was stopped and 30.75 g of chlorothalonil (technical grade) was added to the aqueous solution. Shear was started slowly to avoid splashing and then increased gradually until a homogeneous suspension was produced. Typically it took about 10-15 minutes to provide a uniform suspension. Any residual powder sticking to the side of the beaker was removed with a spatula and added into the slurry.

A 250 ml stainless steel (SS) beaker was chained into the clamp and a propeller type stirrer was positioned 1/4 inch above the base of the beaker. The beaker was kept under ice and the propeller was positioned down the center of the beaker. Grinding media equal to 70% of the formulation volume was weighed.

Weight of the media mill, required for 100 g charge was calculated as follows, assuming 75% volume fraction of the charge.
Volume of 100 g Charge=100/1.15 (Sp. Gr)=86.95 mL (1)
75% Volume=86.95×0.75=65.2 mL (2)
Weight of media required to be used for 100 g Charge=65.2 mL of volume×5.5 density media=359 g (3)

The slurry from the Waring blender cup was poured into a SS milling beaker; Then the grinding media was added. The motor was turned on to 5000 rpm for 15 minutes and the speed was checked, at 5-minute interval with tachometer. The liquid and media was transferred into 40 mesh sieve, taped to a plastic funnel base attached to vacuum. Vacuum pump was turned on, and the media was pressed out of the liquid with a spatula and collected liquid into flask. The collected liquid was weighed. Appropriate quantity of KELZAN®/PROXEL GXL® stock solution [2.0% KELZAN®/3.33% PROXEL GXL® in water] was added at the rate of 4.49 g per 100 g of liquid collected, and was shaken vigorously to disperse KELZAN® through the liquid.

Procedure for Percent Suspendability (CIPAC test # MT 161)

Suspendability tests on the suspension concentrate was performed in 1000 ppm hard water according to CIPAC Test # MT161. The test was run using a calculated weight of the suspension concentrate to give 1% active ingredient by weight when diluted into 250 ml of hard water. After 4 hours, 75% of the dispersion was decanted off and discarded, and the remaining 25% of the dispersion was centrifuged at 3000 rpm for 20 minutes, followed by drying and weighing of the solid active retraced. The results are reported as percent suspended active by weight.
% Suspendability=111 (C−Q)/C% (4)
C=W×A/100 (5)
W=Wt of Formulation used for analysis (6)
A=% Wt of Chlorothalonil in Formulation (7)
Q=Wt of Dried Material (8)
Method for Determination of Rain-fastness

Preparation of Standard Chlorothalonil Solution

About 50 mg of chlorothalonil technical (99% pure, the same material used to prepare suspension concentrates was used for evaluation) was accurately weighed into a 100 mL volumetric flask, added isopropyl alcohol (IPA), and dissolved by shaking and the volume was made up with IPA. This stock solution (500 ppm) was used to prepare standard solutions from 25 ppm to 200 ppm by dilution in IPA as shown below:
5 mL of 500 ppm was diluted to 100 mL to produce a 25 ppm standard solution;
5 mL of 500 ppm was diluted to 50 mL to produce a 50 ppm standard solution;
5 mL of 500 ppm was diluted to 25 mL to produce a 100 ppm standard solution;
15 mL of 500 ppm was diluted to 50 mL to produce a 150 ppm standard solution; and
20 mL of 500 ppm was diluted to 50 mL to produce a 200 ppm standard solution.

UV spectra were obtained from the above standard solutions using UV-visible spectrophotometer (Model-Cintra 40) attached to a computer (Model-HP Vectra XA). The absorption at 325 nm, was read from each of the spectra and a calibration curve was constructed by plotting absorption at 325 nm versus concentration using least squares approximation. The data was a good fit for linear regression with Slope=0.0079, intercept Y=0.0012, and regression coefficient term R²=0.9999.

Preparation of Slides

2.5 g (Xg) of 40% (S %) chlorothalonil concentrate was weighed in a 100 mL volumetric flask, and was diluted to 100 mL to prepare 1% suspension.

Clean microscope slides [1″×4″] were tarred on a Mettler balance, added about 0.5 g (Wg) of the diluted 1% chlorothalonil suspension in each slide, and the exact weight of the material added was determined. The slides were air-dried under a laboratory hood. A total of 12 slides were prepared. Slides 1 and 2 were kept as unwashed slides in duplicate. The remaining 10 slides containing dried material (SC), were washed with Vᵢ mL (Vᵢ ranging from 0 to 25) deionized water as follows, [the water was applied from a dispensing pipette on the slides kept at an angle of 45 degree]:

Slides 3 and 4 with 5 mL; slides 5 and 6 with 10 mL; slides 7 and 8 with 15 mL; slides 9 and 10 with 20 mL; and slides 11 and 12 with 25 mL.

The above washed slides were air-dried. The dry solid remaining on each treated slide was extracted and washed with IPA quantitatively into a 50 mL volumetric flask. The combined extract and IPA washings were made up to 50 mL. The UV absorption at 325 nm was read via the UV spectra obtained from each sample. The recovered chlorothalonil was read as ppm (P) from the calibration curve.

Calculation of Percent Chlorothalonil

The percent chlorothalonil recovered from each slide was calculated as follows:
Let P represent ppm concentration of chlorothalonil in 50 mL of extract, obtainable from Wg diluted SC.
Let Xg of S % concentrate be diluted to 100 mL to prepare about 1% diluted SC.
   Wt of chlorothalonil in 50 Ml of extract=Wt of chlorothalonil recovered from Wg diluted SC.=(P10⁻⁶ g/g)50 mL 1 g/mL (assuming the diluted Sc has a density of 1 g/mL)=50 P 10⁻⁶ g (9)
   Theoretical amount of chlorothalonil in Wg of diluted SC=Xg [(S/100). Wg/100 mL (1 mL/g)]=X S W 10⁻⁴ g (10)
   % Chlorothalonil recovered in the washed slide=[50 P 10⁻⁶ g/X S W 10⁻⁴ g]100=50 P/X S W. (11)
   Typically, X=0.5 g, S=40%, and W=2.5 g, in such a case,
   % chlorothalonil recovered is given by P=ppm concentration of chlorothalonil found in 50 mL extract.

### Formulations and Results

### CONTROL EXAMPLE 1

Commercially available 40% Chlorothalonil suspension concentrate (supplied by Avicia) was evaluated for suspendability and rain-fastness as described above, after diluting the concentrate to 1% chlorothalonil. Dispersibility was in the order of about 50-60%. Rain-fastness was poor. 50% chlorothalonil was washed off by a 25 mL water wash.

### INVENTION EXAMPLE 2

The commercially available 40% chlorothalonil suspension concentrate was mixed with the commercially available Bohme product ASS-HF-NT 800 (14% solid) in the weight ratio 2:1, and diluted to 1% chlorothalonil. The rain-fastness was 100% after wash off with 5, 10, 15, 20, and 25 mL water simulating about 1 inch rain (i.e., Zero wash off). Suspendability remained unchanged at 50-60%.

### EXAMPLE 3

Example 2 was repeated except the ratio of 40% chlorothalonil suspension concentrate and commercially available Bohme product ASS-HF-NT 800 was 1:0.4. The rain-fastness was 100% after wash off with 5, 10, 15, 20, and 25 mL water simulating about 1 inch rain. Suspendability remained unchanged at 50-60%.

### EXAMPLE 4

Example 2 was repeated except the ratio of 40% Chlorothalonil suspension concentrate and commercially available Bohme product ASS-HF-NT 800 was 1:0.3. The rain-fastness was 98% after wash off with 5, 10, 15, 20, and 25 mL water simulating about 1 inch rain. Suspendability remained unchanged at 50-60%.

### EXAMPLE 5

Example 2 was repeated except the ratio of 40% Chlorothalonil suspension concentrate and commercially available Bohme product ASS-HF-NT 800 was 1:0.2. The rain-fastness was 90+% after wash off with 5, 10, 15, 20, and 25 mL water simulating about 1 inch rain (i.e., 5% wash off). Suspendability remained unchanged at 50-60%.

### EXAMPLE 6

Example 2 was repeated except the ratio of 40% chlorothalonil suspension concentrate and commercially available Bohme product ASS-HF-NT 800 was 1:0.1. The rain-fastness was 85+% after wash off with 5, 10, 15, 20, and 25 mL water simulating about 1 inch rain (i.e., 10% wash off). Suspendability remained unchanged at 50-60%.

### EXAMPLE 7

A suspension concentrate (40% chlorothalonil) similar to Example 1 was prepared using a modification of the composition shown in Table 1, replacing 0.5% Easy-Sperse® with 1% Lignosulfonate (Reax® 100M supplied by Westvaco), and adjusting the amount of water to 100%. Suspendability and rain-fastness of this concentrate was evaluated as described, after diluting the concentrate to 1% chlorothalonil. Dispersibility was excellent at >90%. However rain-fastness was poor at 40%. 60% chlorothalonil was washed off by a 25 mL water wash.

### EXAMPLE 8

The suspension concentrate of Example 7 was mixed with the commercially available Bohme product ASS-HF-NT 800 in the weight ratio 2:1, and diluted to 1% chlorothalonil. The rain-fastness was 90% after wash off with 5, 10, 15, 20, and 25 mL water simulating about 1 inch rain (i.e., 10% wash off). Suspendability remained unchanged at >90%.

### EXAMPLE 9

A suspension concentrate (40% chlorothalonil) similar to Example 1 was made by using a modified composition shown in Table 1, replacing 0.5% Easy-Sperse® with 0.5% naphthalene sulfonate formaldehyde condensate (Morewet® D 425, supplied by Witco/Akzo Nobel Co), and adjusting the amount of water to 100%. Suspendability and rain-fastness of this concentrate was evaluated as described, after diluting the concentrate to 1% chlorothalonil. Dispersibility was excellent at >90%. However rain-fastness was only good. About 10% chlorothalonil was washed off by 25 mL water wash.

### EXAMPLE 10

The suspension concentrate of Example 9 was admixed with the commercially available Bohme product ASS-HF-NT 800 in the weight ratio 2:1, and diluted to 1% chlorothalonil. The rain-fastness was 95% after wash off with 5, 10, 15, 20, and 25 mL water simulating about 1 inch rain (i.e., zero wash off). Suspendability remained unchanged at >90%.

### EXAMPLE 11

A suspension concentrate of IPBC (iodopropargyl butyl carbamate) was prepared by using 25% IPBC in the place of 40% chlorothalonil in Table 1, and making up the total with water to 100%. The above composition was evaluated for suspendability and rain-fastness as described, after diluting the concentrate to 1% IPBC. Dispersibility was in the order of about 80-85%. Rain-fastness was poor. 50% IPBC was washed off by a 25 mL water wash.

### EXAMPLE 12

Example 11 was repeated except the 25% IPBC suspension concentrate was admixed with the commercially available Bohme product ASS-HF-NT 800 (14% solid) in the weight ratio 2:1, and diluted to 1% IPBC. The rain-fastness was 100% after wash off with 5, 10, 15, 20, and 25 mL water simulating about 1 inch rain (i.e., Zero wash off). Suspendability remained unchanged at 80-85%.

### EXAMPLE 13

Example 1 was repeated except 40% chlorothalonil suspension concentrate was prepared according to procedure and composition given in Table 1 using 0.5% Easy-Sperse® (disperse) as solid [2% commercially available 25% dispersant solution] and 2.5% PVP as dispersant/co-dispersant combination. The suspendability was 90% and the rain-fastness was 90% with 25 mL water wash.

### EXAMPLE 14

Example 13 was repeated except 40% chlorothalonil suspension concentrate and commercially available Bohme product ASS-HF-NT 800 were mixed in the weight ratio 1:0.3. The rain-fastness was 100% after wash off with 5, 10, 15, 20, and 25 mL water simulating about 1 inch rain. Suspendability remained unchanged at 90%.

### EXAMPLE 15

Example 13 was repeated except the ratio of 40% chlorothalonil suspension concentrate and commercially available Bohme product ASS-HF-NT 800 was 1:0.2. The rain-fastness was 95+% after wash off with 5, 10, 15, 20, and 25 mL water simulating about 1 inch rain (i.e., 5% wash off). Suspendability remained unchanged at 90%.

### EXAMPLE 16

Example 13 was repeated except the ratio of 40% chlorothalonil suspension concentrate and commercially available Bohme product ASS-HF-NT 800 was 1:0.1. The rain-fastness was 96% after wash off with 25 mL water simulating about 1 inch rain (i.e., 5% wash off). Suspendability remained unchanged at 90%.

### EXAMPLE 17

Composition of Example 11, IPBC 25% suspension concentrate was mixed thoroughly with composition of Example 13, 40% chlorothalonil suspension concentrate to produce a mixed suspension concentrate to provide 20% chlorothalonil and 10% IPBC, and making up with water to 100%.

Suspendability and rain-fastness were evaluated with the above composition after diluting to 1% chlorothhalonil and 0.5% IPBC. The suspendability was >80% and rain-fastness was poor with 60% wash off with 25 mL water wash.

### EXAMPLE 18

Mixed suspension concentrate with 20% chlorothalonil and 10% IPBC shown in Example 17 was mixed well with the commercially available Bohme product ASS-HF-NT 800 in the weight ratio 2:1.

Suspendability and rain-fastness were evaluated with the above composition after diluting to 1% chlorothhalonil and 0.5% IPBC. The suspendability was >80% and rain-fastness was 100% with ZERO wash off with 25 mL water wash.

Examples 2 through 10, 12, and 13 through 18 were repeated except the rain-fast additive was added at the same rate (with respect to the active ingredient and rain-fast agent in the same weight ratio), after dilution of the concentrates (not containing the rain-fast agent). The results of rain-fastness were essentially similar to the corresponding examples where the rain-fast additive was added directly to the concentrate.

Sustained Release Screening Examples

Various formulations (described in Examples 18, 19 and 20) were diluted to contain 1,000 ppm of the active ingredient(s). The cream face of gypsum board samples (2×2×½ in.) were brush coated with each formulation and allowed to dry for 24 hours. The treated gypsum samples were then placed on a Petri dish and water was added to saturate the sample. The water saturated gypsum samples were then inoculated with a mixed fungal inoculum (Aspergillus niger, Penicillium funiculosum and Stachybotrys chartarum) containing approx. 10⁵ spores/ml. Samples were incubated at 28° C., 80% RH for 30-45 days and rated for the presence or absence of fungal growth on the treated surface. Samples showing no growth were re-inoculated and incubated for another 30-45 days. Results are shown in Table 2.

### EXAMPLE 19

Commercially available 40% chlorothalonil shown in Example 1 was used in the inoculation screening as shown above.

### EXAMPLE 20

Example 2 was used in the inoculation screening as shown above. Results of fungal growth and protection are shown below in Table 2.

TABLE 2
Presence (+)_/ Absence (−) of Fungal Growth
on the Cream Face Surface Gypsum Board

| Formulation | Inoculation 1 | Inoculation 2 |
|---|---|---|
| Control | ± | ± |
| Formulation 19 | = | ± |
| Formulation 20 | = | = |
| Formulation 18 | = | = |

The use of adhesion promoter together with an environmentally acceptable crosslinking in ASS-HF 800 NT can provide a stable water beading in water based wood treatments. HF 800 NT also can be used to provide improved adhesion and water repellent properties for many different substrates. For example, HF 800 NT 1-2% diluted in water can be mixed with fungicides to design wood treatments for dipping and pressure brushing and spraying methods.

The used metal compound is stable in water based formulations and works by reacting with functional groups (such as carboxyl, hydroxyl, oxide etc.) on the surface of the substrates which allows bonding, to functional groups in the resin. The production of a covalent bond between the substrate and the binder resin significantly enhances the adhesion properties.

Once crosslinked upon drying, the latent crosslinking system shows in carboxylated polymers such as acrylics and styrene—acrylics also an enhanced water resistance.

The metal complex compound is also successfully incorporated in SUN-CARE® (ISP) light protecting system.

Accordingly, HF 800 NT in water-based paint systems are suitable to:
Crosslink resins to give improved physical and chemical properties.
Improve the adhesion of wood treatments.
Reduce the free radical initiated decomposition of paint films.
Enhance water resistance.
Develop a lower toxicity alternative to current solvent based paint systems.

Other use applications of the invention include the following:
Additive to suspension concentrates.
Additive to spray solutions.
Coating agent to water dispersible granules.
Coating agent on fertilizer granules.
Coating/protective agent on surfaces for controlled release of protectants.

### EXAMPLE 21

Commercial Gro-Green® Fertilizer 5/10/5 fertilizer granule, was used for coating with the polymer dispersion HF 800 NT. The granule composition was follows: 5% N (1% ammoniacal, 4% urea nitrogen); 10% P (P205); 5% K (K2O).

Laboratory Coating Procedure

Typically 98 g of the fertilizer granule was charged in a 2 oz stoppered wide-mouth bottle. Then 2.0 g of a coating solution (commercially available ASS HF 800 NT containing 14% solid polymer and about 2% free ammonia) was added and mixed thoroughly for a period of 30-60 minutes in an automatic rocking shaker. The resultant charge was transferred into a glass tray and dried for a period of 24 to 72 hours. The dried granules were examined through a microscope at 100-250 magnification; more than 90% coverage was estimated. A blank sample was prepared by coating the commercial fertilizer with 2% aqueous ammoniacal solution added, i.e. 98 g fertilizer and 2 g aqueous ammonia solution.

The following experimental set up was used for rain stimulation and sample collection: a 30 mesh 3 inch diameter standard testing sieve, containing the fertilizer sample, was placed over a filter funnel having at least 3 inches in diameter. A paper filter was placed in the funnel to filter out powders from the solution. At the collection end of the funnel, a 20 ml vial was positioned to collect the filtrate. The filter paper was pre-wetted by spraying 6 ml of water onto the funnel.

Then 40 g of treated fertilizer granules was placed on the sieve and 12 ml of distilled water was sprayed at a distance of 3 inches over the fertilizer for 20 seconds with a manual spray container. (The amount of water was determined by measuring the amount of spray needed to deliver 12 ml). The liquid was then allowed to drop through the sieve onto the filter paper where it was filtered and collected with a 20 ml vial placed under the funnel. The filtrate was collected in each vial for the duration of 7 to 15 minutes. Afterwards, the vial is labeled and replaced. Another 12 ml of water was sprayed at a distance of 3 inches. After 10 to 13 vials were collected, the amount of liquid in each vial was determined by weight. The samples in each vial was then analyzed for total nitrogen.

The granules treated with ASS HF NT 800 polymer retained a much higher percentage of nitrogen compared to the reference sample treated identically except that it did not contain any polymer additive.

### EXAMPLE 22

Commercially available cotton and polyester swatches were subjected to a wash cycle using a commercial laundry detergent, followed by wash and rinse cycles. A commercial fragrance solution was added in the rinse cycle. The washed/rinse swatches were then dried. Similarly, an amount of ASS HF NT 800 product was added at the rate of 0.1% in the rinse cycle. The washed/rinsed fabrics also were dried. The samples treated with ASS HF NT 800 retained its fragrance for a prolonged period of time when exposed to the air whereas swatches not treated with additive did not retain its fragrance.

While the invention has been described with particular reference to certain embodiments thereof, it will be understood that changes and modifications may be made which are within the skill of the art. Accordingly, it is intended to be bound only by the following claims, in which:

1. A rain-fast bioactive composition comprising:
(a) a bioactive ingredient, and
(b) a suspension concentrate of a latex polymer emulsified with an in-situ crosslinked hydrocarbon polymer.

2. A rain-fast bioactive composition according to claim 1 wherein (b) comprises 12-14% by weight of said polymer in water.

3. A rain-fast bioactive composition according to claim 1 wherein the weight ratio of (a):(b) is about 1:0.5 to 1:0.01.

4. A rain-fast bioactive composition according to claim 3 wherein said ratio is about 1:0.1 to 1:0.05.

5. A method of increasing the rain-fastness of a bioactive composition which is applied to a substrate comprising including therein a water thickener which is a suspension concentrate of a latex polymer emulsified with an in-situ cross-linked hydrocarbon polymer.

6. A method of sustained release of a biocide from a bioactive composition which is applied to a substrate comprising including therein a water thickener which is a suspension concentrate of a latex polymer emulsified with an in-situ cross-linked hydrocarbon polymer.

7. A method according to claim 1 wherein said substrate is gypsum board or sheet rock.

8. A use formulation including the rain-fast composition of claim 1.
